(19) United States
(12) Patent Application Publication
(10) Pub. No.: US 2020/0112279 A1
(43) Pub. Date: Apr. 9, 2020

(54) VARIABLE FREQUENCY DRIVE WITH INTEGRAL MACHINE CONDITION MONITORING AND PROTECTION SYSTEM

(71) Applicant: Harnam Singh Trehin, North Vancouver (CA)

(72) Inventor: Harnam Singh Trehin, North Vancouver (CA)

(21) Appl. No.: 16/125,583

(22) Filed: Sep. 7, 2018

(51) Int. Cl. H02P 27/06; H02P 29/024; H02P 6/08; H02P 23/00; H02M 5/458

(52) U.S. Cl. CPC H02P 27/06; H02P 29/024; H02M 2001/0025; H02P 23/0077; H02M 5/458; H02P 6/08

(57) ABSTRACT

The present invention provides a variable frequency drive (VFD) which has an integral machine monitoring and protection system to allow continual adjustment of VFD parameters for the optimized operation of a machine. The invention also includes a mentoring and control system provided with self-learning software module. This software module will collect real-time data and stores in the local data-base. When sufficient data is collected the system can be put into the fully or semi-automatic mode. In automatic mode, the system will automatically make decision and adjust operating parameters to operate safely. In semi-automatic mode the system will send new adjustment values/set points for operator to make a decision.

### BACKGROUND

Controlling the operation speed of machinery has long been a goal of industry, in order to allow the machine to be used in more processes as well as for energy conservation. Usually, in the event a machine's speed needs to be adjusted, variable speed controllers are used. In most circumstances, when a machine is driven by an AC motor, variable frequency drives (VFD) are used due to the speed of an AC motor being directly proportional to the frequency of the AC power supplied to the motor.

The method for implementation by manufacturers of VFD is similar to converting constant DC bus voltages to variable voltage and variable frequency output to control the speed of the AC motor. However, VFDs can cause damages to motors, including premature failure of the winding insulation, which may occur when motors are designed for sinusoidal wave forms but the VFD output voltages are square waves with 1.42 times the root mean square value of the nominal AC voltages for which the motors are designed. This prior art occurrence is shown at FIG. 1A and FIG. 1B.

Further problems of using VFDs is because of the high frequency switching of power devices, circulating currents are established within the motor frame and bearings, which causes the motor bearings to heat and fail without any indication. This prior art occurrence is shown at FIG. 2A and FIG. 2B.

Yet another problem of using VFDs is that when a motor speed is near or at the natural mechanical frequency of the system, high amplitude oscillations (i.e., resonance) can cause severe mechanical damage, which requires the avoidance of operation at those speeds.

Last, a machine's health continues to deteriorate due to various factors including aging, operating conditions, little to no maintenance, and environmental factors.

As the above unfavorable conditions go unnoticed, the machine breaks down and manufacturing processes are shut. The owner ends up with a loss of production and high repair costs.

The present invention addresses problems in the art by providing a system and method that allows a machine to utilize VFDs while avoiding the generated problems through the use of a feedback mechanism that provides information on the performance of the machine while the VFD is in use. Such feedback allows the machine operator to shut down the machine to make adjustments or repairs, or for the machine to take automatic actions.

### BRIEF DISCLOSURE OF THE INVENTION

It is an object of the present invention to provide a variable frequency drive (VFD) which has an integral machine monitoring and protection system to allow continual adjustment of VFD parameters for the optimized operation of a machine. Further, it is an object of the present invention to inform the owner about the condition of a machine including its deterioration so that protective means can be taken before a breakdown of the machine. The present invention also has as its object the avoidance of production loss and expensive machine repair costs.

The invention further includes a mentoring and control system provided with a self-learning software module. The software module will collect real time data and store it in a local database. When sufficient data is collected the system can be put into the fully or semi-automatic mode. In automatic mode, the system will automatically make decisions and adjust operating parameters to operate safely. In semiautomatic mode, the system will send new adjustment values/set points for the operator to make decisions.

### BRIEF DESCRIPTION OF DRAWINGS

FIG. 1A shows an actual AC waveform for which motors are designed and expected to operate within;

FIG. 1B shows the output waveform of the variable frequency drive;

FIG. 2A shows the bearing and rotor circulating currents;

FIG. 2B shows the bearing temperature rise due to circulating current;

FIG. 3 is an embodiment of the present invention;

FIG. 4 is an embodiment of the present invention;

FIG. 5 is an embodiment of an aspect of the present invention.

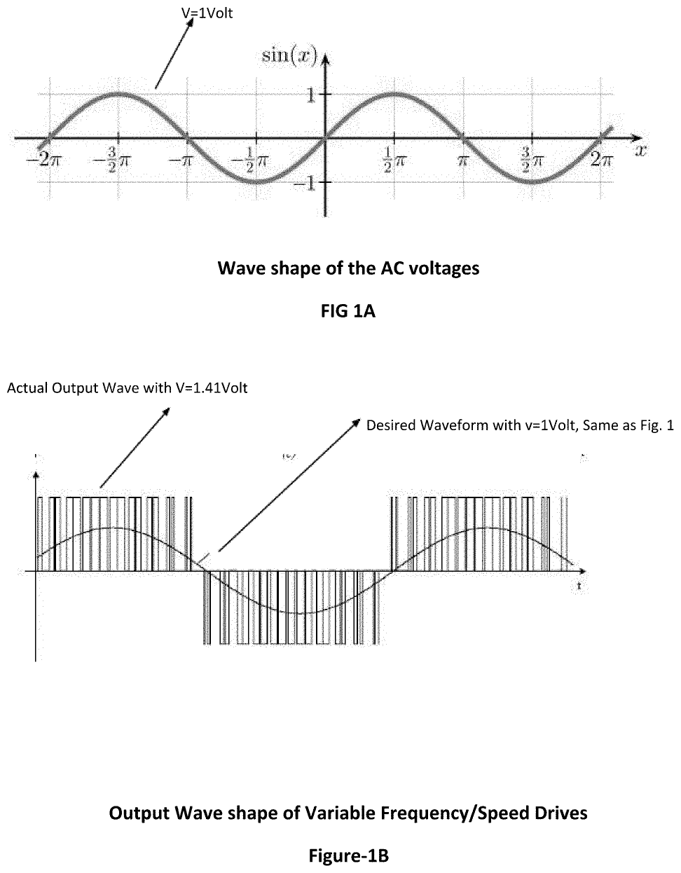

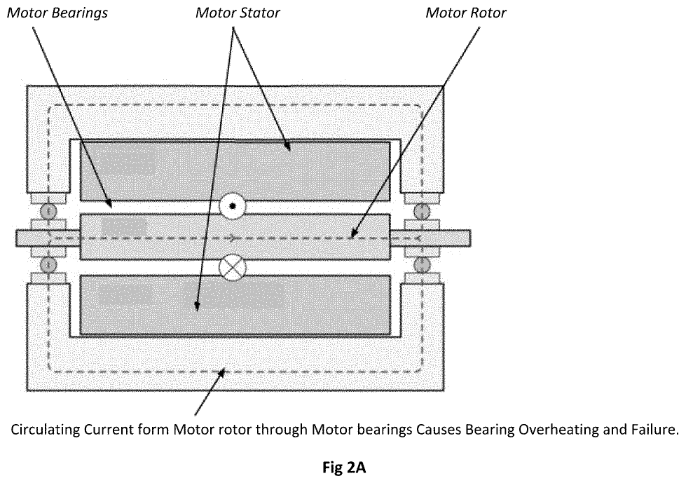

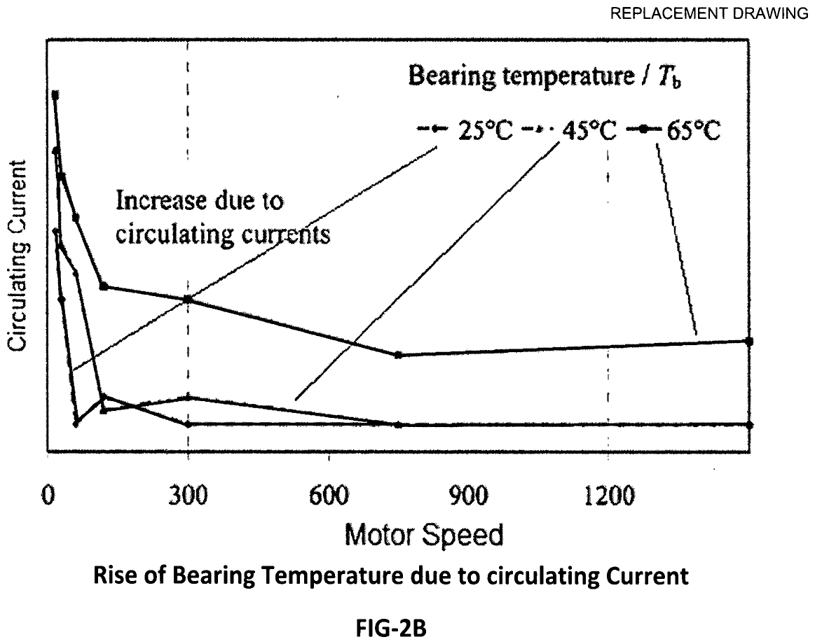

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

As used herein, the term “variable frequency drive” or “VFD” refers to an adjustable-speed drive used in electro-mechanical drive systems for the control of AC motor and torque through the variation of motor input frequency and voltage.

With reference to the figures,

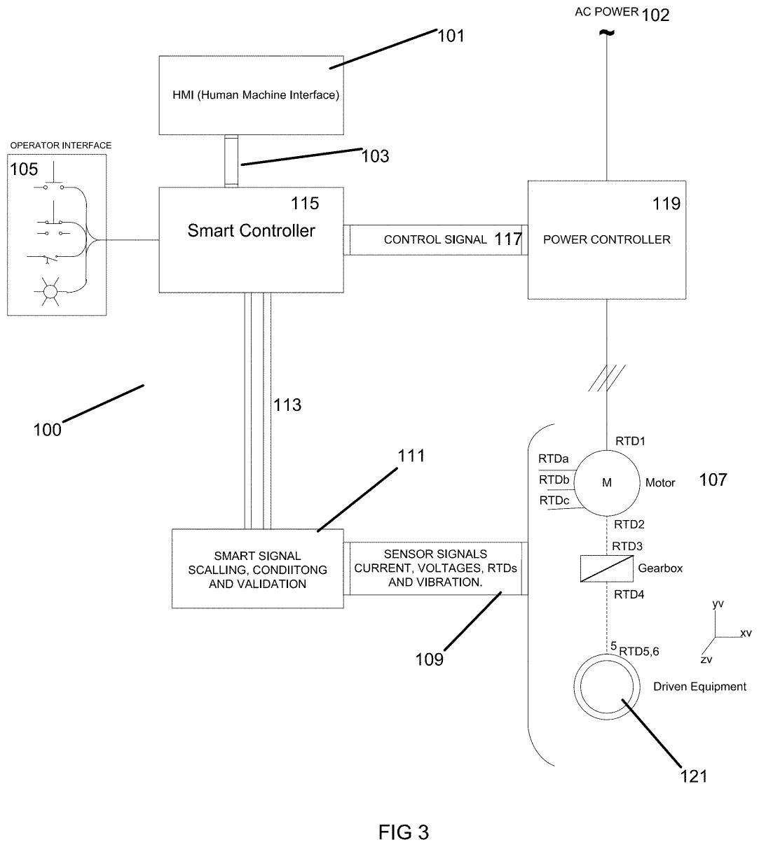

FIG. 3 is an embodiment of the system of the present invention, wherein a VFD system is capable of providing feedback to a user for optimal operation of a machine to which the VFD is attached.

The VFD system 100 includes a human machine interface (HMI) 101, whereby the HMI 101 possesses a user interface allowing an operator of the system 100 to control the system 100. Various types of user interfaces 101 may be provided for use with the system 100, for example, mouse, keyboard, visual screen, display, touchscreen, voice command recognition, pointer system, electronically enabled goggles, biosensors, robotic systems, electronically enabled headbands, electronically enabled wristbands, electronically enabled gloves, electronically enabled glasses, personal devices such as cellular phones, mobile phones, or PDA's. “Electronically enabled” means interfaces that can contain electrical components, electronics components, digital components, a power source, wireless components, communication means such as antennas, microphones, cameras, etc.

The user interfaces 101 may be used single, or in combination with each other of two or more. The user interface 101 may operate with or communicate with the processor by wired means, or by wireless means such as infrared, wireless fidelity (wifi), LAN, WLAN, or telecommunication means.

The user interface 101 is connected via wired or wireless means 103 to a smart controller 115. The smart controller 115 is used to scale signals and filter unwanted noise that may have been introduced during transmission and validates the signal to be used by the smart controller 115 in the control block. Within the smart controller 115 are active and passive filters located within the controller 115 that are required to be used by the controller 115.

The scaled and filter signal, herein known as the control signal 117, is sent to the power controller 119. As will discussed later, the power controller 119 includes a power semiconductor and includes a variety of components. Via the power controller 119, a power source, in one embodiment an AC power source 102, delivers a signal to the motor 121 of the overall machinery 107. The control signal 117 delivered through to the power controller 119 serve as a rectifier to the AC power source 102, thus adjusting the source 102 to fit the needs of the overall machinery 107.

The smart controller 115 is connected via multi-conductor shielded cable 113 to a scaling and signal conditioning component 111. The scaling and signal conditioning component 111 receives feedback signals via at least one feedback sensor 109.

The feedback sensor 109 collects data based on operation of the machinery. The sensor or sensors 109 can collect data related to temperature, vibration, current, voltage, etc. In one embodiment, a combination of temperature sensors, such as thermometers, and vibration sensors, such as accelerometers capable of measuring x, y, and z direction, are used to provide feedback on machine performance. In one embodiment, the sensors of the present invention are positioned within the motor windings of the motor of the machinery 107. Sensors may also be located in varying areas of the machinery 107.

In a further embodiment, three (3) temperature detectors are used, wherein the detectors are platinum resistance thermometers wherein the electrical resistance changes with the temperature. The basic function of these sensors is to continuously measure the temperature of the motor of the machinery 107. The data collected via the detectors is sent to the scaling and conditioning component 111.

The VFD system 100 further includes the use of an operator interface 105. The operator interface 105 allows the operator to control specific aspects of the VFD. In one embodiment, the operator interface 105 includes pushbuttons, selector switches, and potentiometers.

The present invention further includes a method of using a VFD having machine monitoring to control and adjust the operation of a VFD as it drives the motor operations of a machine.

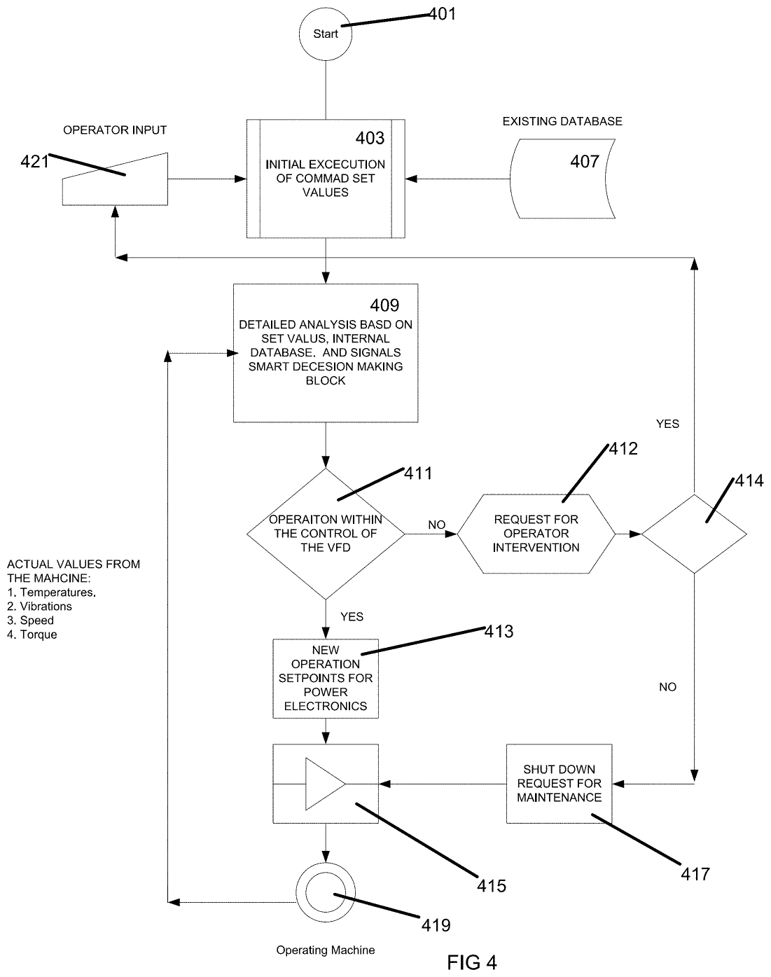

As shown in FIG. 4, upon the pressing of a start button 401, an operator sets values 403 to be adhered to by the system. The values, for example operational parameters such as temperature and vibratory movement, can be derived from existing database values 407 as benchmark values. The operator can also input desired values 421. The initial values are then sent for comparison purposes against real-time machine readings 409. A determination is made, based on the comparison 409, as to whether the machine is operation within the values and control of the VFD 411.

In the event the machine is not operating within the set controls, a request is made for operator intervention 412. At this stage, the operator may adjust the operation of the VFD, such as controlling the speed of the motor. Upon operator intervention, the value of the VFD operator parameters can be changed 414. Alternatively, the operator may not intervene, at which point the VFD may shut down or request to be shut down for maintenance 417.

If the VFD is operating within defined boundaries, new standards or operation setpoints can be set for the electronics 413. Such new standards can be used for operating the machinery 419.

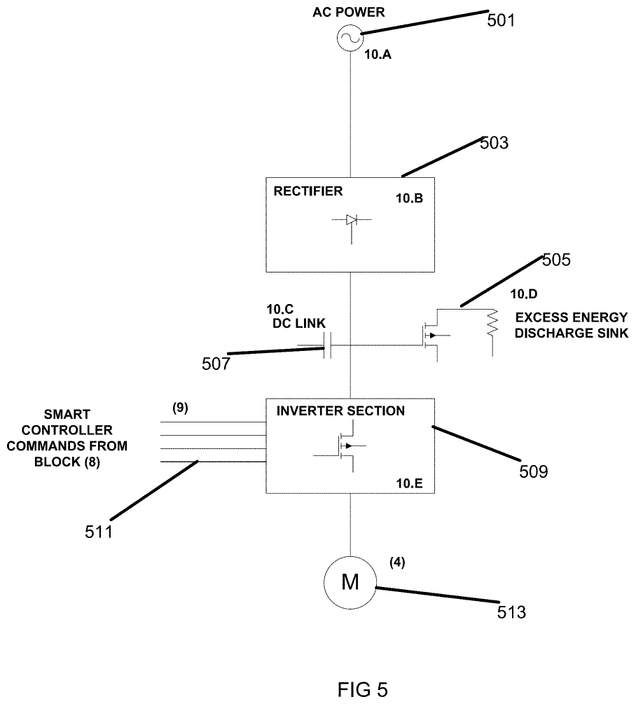

FIG. 5 is an embodiment of the AC Power signal being delivered to the machinery via power controller.

In one embodiment, the power controller include the components of rectifiers, capacitor bank on a DC link, controlled excess energy discharge sink activated by a smart controller, and power inverter which converts DC power to variable voltage and variable frequency.

As shown, the AC power signal 501 is rectified for smoothing purposes 503. The signal 501 is further treated via heat sink 505 and DC signal 507. Data from the smart controller 511 is sent to adjust the signal to make it suitable for the attached machinery 513, wherein the signal from the smart controller 511 is subject to inverter componentry.

Although various embodiments of the present invention have been shown and described, modifications may occur to those skilled in the art upon reading the specification. The present invention includes such modifications and is limited only by the scope of the claims.

1. (canceled)

2. (canceled)

3. (canceled)

4. (canceled)

5. (canceled)

6. (canceled)

7. A method of using a variable frequency drive apparatus for controlling, monitoring, and adjusting the operation of a variable frequency drive as it drives the motor of a machine, comprising the steps of:
pressing a start button positioned on said variable frequency drive apparatus;
setting operation values to be adhered to by said motor of said machine;
comparing said operational values with real-time machine reaching values;
determining whether said motor is operating within the parameter of said set operational values; and
in the event said motor is not operating within said operational values, adjusting the operation of said variable frequency drive; or
alternatively, shutting down said motor of said machine for maintenance.

8. The method of using a variable frequency drive apparatus for controlling, monitoring, monitoring, and adjusting the operation of a variable frequency drive of claim 7, wherein setting said operation values is performed automatically using benchmark values stored on an existing database.

9. The method of using a variable frequency drive apparatus for controlling, monitoring, monitoring, and adjusting the operation of a variable frequency drive of claim 7, wherein determining whether said motor is operating within the parameter of said set operational values occurs by collecting one or more real-time readings from one or more sensors located within the proximity of said motor of said machine and comparing said real-time readings with historical readings.

10. The method of using a variable frequency drive apparatus for controlling, monitoring, monitoring, and adjusting the operation of a variable frequency drive of claim 9, wherein readings from one or more sensors includes obtaining readings from temperature sensors, vibration sensors, voltage sensors, or current sensors.
